(19) United States
(12) Patent Application Publication
(10) Pub. No.: US 2015/0193827 A1
(43) Pub. Date: Jul. 9, 2015

(54) SYSTEMS, METHODS, AND COMPUTER PROGRAM PRODUCTS FOR GENERATING TARGETED COMMUNICATIONS BASED ON ACQUIRED INFORMATION FROM A MOBILE DEVICE

(71) Applicant: JVL VENTURES, LLC, New York, NY (US)

(72) Inventors: Joseph B. Pearson, Cedar Park, TX (US); Susan I. Novell, Reno, NV (US); James P. Stapleton, Plano, TX (US); Krishna Doddamane, Allen, TX (US); Michael G Smith, JR., Fairview, TX (US)

(21) Appl. No.: 14/591,709

(22) Filed: Jan. 7, 2015

Related U.S. Application Data
(60) Provisional application No. 61/925,048, filed on Jan. 8, 2014.
(60) Provisional application No. 61/925,050, filed on Jan. 8, 2014.
(60) Provisional application No. 61/925,054, filed on Jan. 8, 2014.

(51) Int. Cl. G06Q 30/02

(52) U.S. Cl. CPC G06Q 30/0269; G06Q 30/0267; G06Q 30/0222

(57) ABSTRACT

System, methods, and computer readable mediums are provided for generating a targeted communication. A mobile device transmits identification information to a contactless reading unit, embodied in one example as a merchant point-of-sale system. The contactless reading unit transmits the received identification information to a merchant system. The merchant system updates a profile corresponding to the identification information based on the received identification information. The merchant system determines a type of targeted communication for transmission based on the profile, and generates the targeted communication based on the determination.

### CROSS REFERENCE TO RELATED APPLICATION

This application claims priority to U.S. Provisional Application Nos. 61/925,048, 61/925,050, and 61/925,054, each of which was filed Jan. 8, 2014, and the contents of which are herein incorporated by reference.

### BACKGROUND OF THE INVENTION

1. Field of the Invention

The present invention generally relates to acquiring data from a mobile device, more particularly, to systems, methods, and computer program products for generating targeted communications based on acquired information from a mobile device.

2. Related Art

Mobile devices, e.g. mobile phones and tablets, have become multidimensional tools capable of accomplishing a variety of tasks. No longer confined to merely making and receiving phone calls, mobile devices are capable of accessing email, the Internet, and remote networks. These added capabilities are a result of decades of improvement in mobile technology. Mobile processors are quicker and more efficient. Battery life is longer. Color displays are now the norm, with resolutions approaching the limit of human perception. In light of these advances, consumers are turning to their mobile devices to make purchases, resulting in a burgeoning mobile commerce environment.

In a mobile commerce environment, a user uses his/her mobile device to browse, compare, buy, and review products and services. The rise of mobile commerce has also resulted in a rethinking of how consumers and merchants interact. Traditionally, merchants have sought information on their customers' buying habits. With this information, merchants are better equipped to offer their customers more useful sales and offers, thereby increasing customer satisfaction while simultaneously increasing sales. However, collecting and analyzing this information has been a cumbersome, laborious process for both merchant and consumer.

To attempt to collect relevant information, merchants would create loyalty programs. A typical loyalty program required the consumer to fill out a form to enroll, often after purchasing the merchants' products. As a reward, the consumer would be able to take advantage of sales offered by the merchant. If the consumer did not enroll, however, he or she would miss out on the sales. As such, the consumer was often compelled to take the additional time to fill out the requisite forms to join the loyalty program. Not only is this an inconvenience, but the loyalty program was most likely only valid for the particular merchant, or chain, that the consumer was patronizing. If the consumer went elsewhere, he or she would have to enroll in a different loyalty program. This impediment often led consumers to only enroll at stores they patronized frequently, meaning that merchants typically only had access to purchase information from a subset of his or her customers. In addition to these flaws, the traditional loyalty program relied upon the consumer to either provide their loyalty card or, if they did not have the card on them, to provide personal information such as a telephone number to identify himself or herself to the merchant prior to checking out. This additional step beyond paying delays the checkout process and thus disincentives the consumer to participate. Therefore, there is a need for an improved technological system to provide suitable data collection for the merchant while offering the consumer incentives to participate.

### BRIEF DESCRIPTION

The present invention provides methods, apparatuses, and computer readable mediums for generating a targeted communication based on acquired information from a mobile device.

In one embodiment, a method of generating a targeted communication is provided. The method includes receiving, updating, determining, and generating steps. In the receiving step, user identification information from a contactless reading unit is received. In the updating step, a profile corresponding to the user identification information is updated based on the received user identification information. In the determining step, a type of targeted communication for transmission is determined. In the generation step, a targeted communication is generated based on the determination.

In another embodiment, an apparatus for generating a targeted communication is provided. The apparatus includes a communication unit, a memory, and an analytic engine embodied in a processor. The communication unit is constructed to receive user identification information from a contactless reading unit. The memory is constructed to store a database that includes a profile corresponding to the received user identification information. The analytic engine is constructed to: update the profile corresponding to the received user identification information based on the received user identification information, determine a type of targeted communication for transmission based on the profile, and generate a targeted communication based on the determination.

In yet another embodiment, a non-transitory computer-readable medium that stores a program configured to a cause an apparatus to execute a method of generating a targeted communication is provided. The method includes receiving, updating, determining, and generating steps. User identification information is received from a contactless reading unit. A profile corresponding to the user identification information is updated information based on the received user identification information. A type of targeted communication for transmission is determined based on the profile, and the targeted communication is generated based on the determination.

In yet another embodiment, a method of generating a user account is provided. User identification information is received from a contactless transaction unit, and a user account is generated based on the received user identification information.

### BRIEF DESCRIPTION OF THE DRAWINGS

The features and advantages of the present invention will become more apparent from the detailed description set forth below when taken in conjunction with the following drawings.

FIG. 1 is an overview of a mobile commerce system.

FIG. 2 is a block diagram of components in the system.

FIG. 3 is a block diagram illustrating components involved in a first embodiment directed to a frequency type targeted communication system.

FIG. 4A is a sequence diagram illustrating features of the first embodiment directed to the frequency type targeted communication system.

FIG. 4B is a sequence diagram illustrating features of a reward redemption process according to the first embodiment.

FIG. 5 is a block diagram illustrating components involved in a second embodiment directed to a frequency type targeted communication system using an unattended point of sale system.

FIG. 6A is a sequence diagram illustrating the second embodiment directed to a frequency type targeted communication system using an unattended point of sale system.

FIG. 6B is a sequence diagram illustrating a reward redemption process according to the second embodiment.

FIG. 7 is a block diagram illustrating a data acquisition system corresponding to the third, fourth, fifth, and sixth embodiments.

FIG. 8. is a sequence diagram illustrating features of the third embodiment directed to a pseudo loyalty account generation system.

FIG. 9 is a sequence diagram illustrating features of the fourth embodiment directed to an automated loyalty program enrollment system.

FIG. 10A is a sequence diagram illustrating features of the fifth embodiment directed to a targeted communication system.

FIG. 10B is a sequence diagram illustrating a reward redemption process according to the fifth embodiment.

FIG. 11 is a sequence diagram illustrating features of the sixth embodiment directed to a targeted communication system that uses historically enriched data.

FIG. 12 is a block diagram of a general or special purpose computer according to any example embodiment.

### DETAILED DESCRIPTION

### Mobile Commerce System

This description is not intended to limit the application of the example embodiments presented herein which are directed to, for example, using identification information to enroll and/or participate in loyalty programs. In fact, after reading the following description, it will be apparent to one skilled in the relevant art(s) how to use identification information from a mobile device in other instances where such information may be a useful analytical tool. Different analytic engines may be developed to use received identification information to generate targeted communications based upon the needs of a particular field, including, for example, transit, real estate, mobile commerce, internet commerce, entertainment, and the service industry, among others.

The terms “application”, “applet”, “widget”, and/or the plural form of these terms are used interchangeably herein to refer to an application (functioning independently or in conjunction with other applications) or set or subset of instructions or code, which when executed by one or more processors (e.g., in a mobile device, card reader, terminal, point of sale (POS) system, or server) causes the processor(s) to perform specific tasks. For example, a wallet application can be used to conduct transaction or interface related functions such as storing, processing, accessing or transmitting financial, loyalty, offer, membership, or account data. A wallet application may also incorporate or interact with one or more payment applications, such as ExpressPay from American Express®, Discover® Network Zip^{SM}, MasterCard® PayPass™ and Visa payWave™ payment applets.

Generally, commerce-related services are made available through a suite of applications available on several different platforms. The first application (or suite of applications) exists onboard a server within a mobile commerce (MoCom) platform 135. The MoCom platform 135 is responsible for the management of consumer data, including loyalty accounts and offers. In addition, the MoCom platform 135 serves as a campaign manager for offers, providing a remote data store for offers made available to the consumer via the available merchant portals within a wallet application.

A second application exists onboard a mobile device in the form of a mobile wallet application (also referred to as a mobile wallet). The mobile wallet provides the consumer's primary user interface (UI) and additional commerce application services through which the wallet application may access additional resources onboard a secure element (SE) of a mobile device.

A third application exists onboard a secure element of a mobile device in the form of a JavaCard applet. This applet stores commerce-related data such as loyalty and offer data and provides an interface through which the data may be managed. The applet is accessible through the use of Application Protocol Data Unit (APDU) commands as defined in International Standards Organization (ISO) 7816-4.

The fourth application exists onboard an NFC-enabled reader (referred to herein simply as a “contactless reader”). The contactless reader can be either a stand-alone device or attached to (and managed by) a point of sale (POS) terminal. This application facilitates or provides access to the interface with a secure element on a mobile device, performing specific tasks that optimize the APDU command/data exchange tasks. For example, it includes the reading of loyalty, offer, and identification information following the placement of a mobile device in proximity of a reader (i.e., a “tap”).

A fifth application (or suite of applications) exists onboard a merchant POS system, including a POS terminal and any additional merchant-specific hardware/software. These applications manage the data related to payment/loyalty/offers/rewards/identification information received from a secure element on a mobile device via a reader. In most cases, this data will then be forwarded to a corresponding MoCom 135 or merchant specific platform(s).

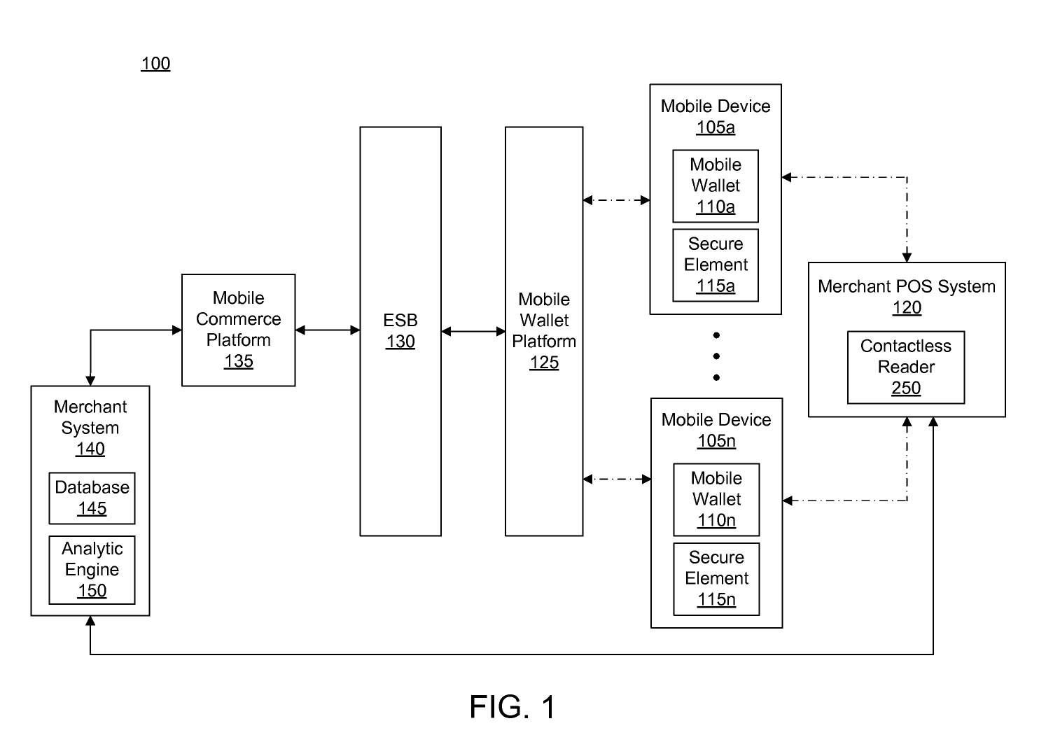

FIG. 1 is a graphical representation of a platform architecture in accordance with an exemplary embodiment. As shown in FIG. 1, system 100 includes mobile devices 105a . . . 105n (hereinafter referred to as mobile device 105). The mobile device 105 is communicatively coupled to a contactless (e.g., proximity or NFC) reader 250 within a merchant POS system 120 and a mobile wallet platform 125. Reader 250 is also communicatively coupled to the merchant POS system 120. The merchant POS system 120 may be within the same housing as the contactless reader 250. Alternatively, the merchant POS system 120 and contactless reader 250 are communicatively coupled with each other but each of these components is housed separately.

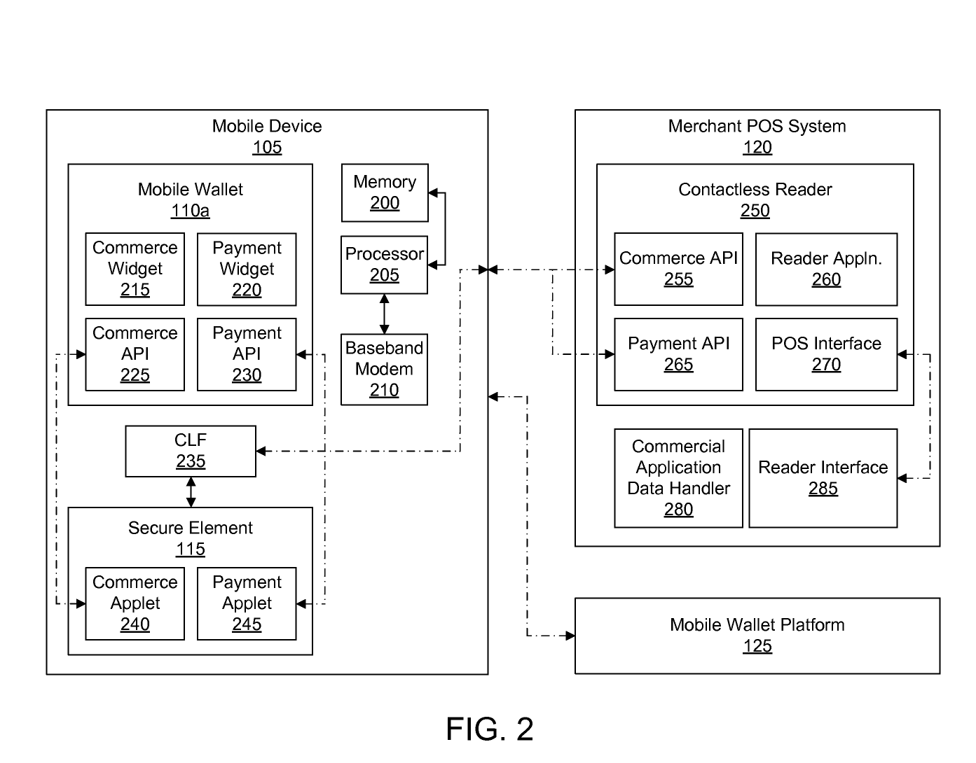

Mobile device 105 may be, for example, a smartphone, tablet, or the like. As illustrated in FIG. 2, the mobile device may include a processor 205, memory 200, a contactless frontend (CLF) 235, a baseband modem 210, and a user interface such as a display (not shown). Baseband modem 210 is a digital modem that is used for mobile network communications. CLF 235 is circuitry which handles the analog aspect of contactless or NFC communications and the communication protocol layers of a contactless transmission link. CLF 235 also is used to exchange data between the contactless reader 250 and a secure element (or SE) 115 contained in mobile device 105, for example, to execute contactless transactions.

Secure element 115 may be implemented as a Universal Integrated Circuit Card (UICC), embedded SE card, secure micro secure digital (microSD) card, and the like. A secure element may also be implemented outside of the mobile device with which it is associated. For example, a secure element may be implemented in a cloud-based, remote, or virtual storage, and the like. Secure element 115 is generally considered secure because it is a self-contained system, including dedicated memory, and is protected by hardware and software hardening techniques that are verified by independent testing.

Secure element 115 includes (e.g., stored thereon) one or more commerce applets 240. Each commerce applet 240 is associated with a commerce service and an account issued by a commerce service provider (SP). A service provider is a company, organization, entity, or the like, that provides services to customers or consumers. Examples of service providers include account-issuing entities such as banks, merchants, card associations, marketing companies, and transit authorities. A service may be an activity, capability, functionality, work, or use that is permitted or provided by a service provider, such as a payment service, credit, debit, checking, gift, offer or loyalty service, transit pass service, and the like.

A commerce service provider can provision (or have provisioned) onto secure element 115 one or more separate commerce applets 240. In addition, other independent service providers can provision (or have provisioned) onto secure element 115 their own commerce applet(s) 240. Generally, a commerce applet 240 stores both loyalty and offers related data, providing an APDU interface through which this data can be managed. Commerce applet 240 operates as a generic storage container, allowing multiple loyalty/offers services to share mechanisms (e.g., secure element, mobile device) for loyalty/offers data management. If memory restrictions and performance requirements limit the amount of loyalty/offers data that can be stored on secure element 115, additional data can be stored in mobile device memory 200 and managed by the consumer via commerce widget 215. For example, any graphic images related to an offer can be stored in memory 200 in order to optimize secure element memory allocation. Loyalty/offers data management can be handled by the corresponding offer platform, loyalty platform, or rewards platform within the mobile commerce platform 135.

Commerce applet 240 includes a cached merchant data table enabling the storage/management of all data related to a given merchant. This allows the commerce data for a given merchant to be pre-loaded in secure element 115 or mobile device 105 by a wallet application. Exemplary commerce elements (and their corresponding tag values used during Tag Length Value (TLV) encoding) that are included in the cached merchant data table are defined below. This data is stored in a record oriented data buffer. In an exemplary embodiment, a merchant identifier (Merchant Identifier) is used as the key field for search/retrieval tasks. Optionally, an index (or hash table) may be created to improve performance.

One or more commerce applets 240 can be loaded onto the secure element 115, for example, during manufacture and/or configuration of the secure element 115 and may be personalized to enable its use to conduct commerce transactions. A commerce applet 240 interfaces with the contactless reader 250 via a commerce application programming interface (API) 255. In an exemplary embodiment, a commerce applet 240 is in the form of a JavaCard applet and is accessible through the use of APDU commands as defined in ISO 7816-4. Particularly, commerce applet 240 communicates commerce elements to reader 250 via secure element 115 using ISO 7816 commands over the NFC ISO 14443 protocol.

Secure element 115 can also include one or more payment applets 245 where each payment applet 245 is associated with a payment service and an account issued by a payment service provider. One or more payment applets 245 also can be loaded onto the secure element 115, for example, during manufacture and/or configuration of the secure element 115 and may be personalized to enable its use to conduct payment transactions. A payment applet 245 interfaces with the contactless reader 250 via payment API 265. In an exemplary embodiment, payment applet 245 is in the form of a JavaCard applet and is accessible through the use of APDU commands as defined in ISO 7816-4. Payment applet 245 also communicates payment elements to the contactless reader 250 via secure element 115 using ISO 7816 commands over the NFC ISO 14443 protocol.

It should be understood that other communications between the aforementioned devices may include communications with or through other intervening systems, hardware, and/or software, and such communications may include receiving, transferring, and/or managing data.

A mobile wallet application 110 stored on mobile device 105 includes instructions which, when executed by the processor of the mobile device 105, cause the mobile device 105 to act as an instrument, for example, for processing transactions such as contactless commerce and/or payment transactions. Mobile wallet 110 communicates, through the use of APDU commands as defined in ISO 7816-4, with the commerce applet 240 via commerce API 225 and to payment applet 245 via payment API 230.

Commerce widget 215 is a component of the mobile wallet 110 that provides an interface for consumers to manage commerce elements (e.g., loyalty card credentials, offers and rewards), for example, through interactions with the display or user interface of a mobile device 105. Commerce widget 215 maintains, for example, a master list of commerce elements present on the handset in a memory of the mobile device (e.g., 200). A subset of offers that have been identified as ready to be used are, in turn, moved to secure element 115 to be communicated to contactless reader 250 and POS terminal 120. Sensitive information, such as loyalty account identifiers, can be stored on secure element 115. Furthermore, each secure element 115 is identified by a unique identification number, which may be either numeric or alphanumeric. Moreover, each mobile wallet itself stores a customer ID (CID), which is a unique number associated with the owner of the mobile wallet. While the CID may be stored in memory 200, since the CID is associated with a unique individual, the CID is preferably stored in the secure element 115, and provided to the contactless reader 250 during a contactless transaction.

Payment widget 220 is a component of the mobile wallet 110 that provides an interface for consumers to manage payment elements (e.g., credit or debit card credentials), for example, through interactions with the display or user interface of a mobile device.

Contactless reader 250 includes a reader commerce application 260 (referred to herein simply as a “reader application”) and a POS interface 270. Contactless reader 250 manages two interfaces: one interface is with the secure element 115 in the mobile device 105 and the other interface is with the merchant POS system 120 which includes a reader interface 285 and a commerce application data handler 280. The functionality of the contactless reader 250 is the same whether the contactless reader 250 is standalone and connected to merchant POS system 120, or is integrated therein. Contactless payment functionality is also contained in the contactless reader 250 but is not shown.

As shown in FIG. 1, mobile device 105 is further communicatively coupled to a mobile wallet platform 125, which in turn is communicatively coupled to the mobile commerce platform 135 through the enterprise service bus (ESB) 130. As noted above, the mobile commerce platform includes the offers platform, loyalty platform, and rewards platform.

Also shown in FIG. 1 is a merchant system 140. The merchant system 140 may be communicatively coupled to the mobile commerce platform 135 and the merchant POS system 120. The merchant system 140 includes a database 145 and analytic engine 150 which are embodied in a processor and memory (not shown). The functionality of the analytic engine 150 is provided by interactions between the processor and the control programs stored in the memory. The merchant system 140 may transmit and receive data from either the mobile commerce platform 135 or the merchant POS system 120. Transmissions through the mobile commerce platform 135 may be further sent, through the ESB 130 and mobile wallet platform 125, to a mobile device 105. Transmissions to the merchant POS system 120 may be through one or more wireless or wired communications (including, for example, telephonic, cell, internet, Ethernet, satellite, or radio communications).

In one embodiment, the mobile device 105 may be used to conduct a contactless transaction at a merchant POS system 120 equipped with the contactless reader 120. The mobile device 105 is placed within a predetermined required proximity of the contactless reader 250 (i.e., taps) causing CLF 235 of the mobile device 105 to communicate with the contactless reader 250 using, for example, NFC ISO 14443 protocols. Contactless reader 250 also communicates with the mobile wallet 110, commerce applet 240, and/or payment applications on the mobile device 105 to execute contactless transactions.

A secure element employs a Proximity Payment System Environment (PPSE) that serves as a directory of available credentials currently stored in secure element 115. Each credential is assigned a corresponding application identifier (AID) associated with a payment application and stored in the PPSE. When an NFC-enabled mobile device containing secure element 115 is placed in the vicinity of an NFC-enabled contactless reader, the contactless reader reads the credential and completes the transaction. Before doing so, however, the reader is initialized.

On mobile device 105, PPSE is an application used to maintain a list of payment applications stored on secure element 115, and provides accessibility to each payment application stored on the mobile device 105 by making them visible or not visible (i.e., accessible) to systems or devices.

### First Embodiment

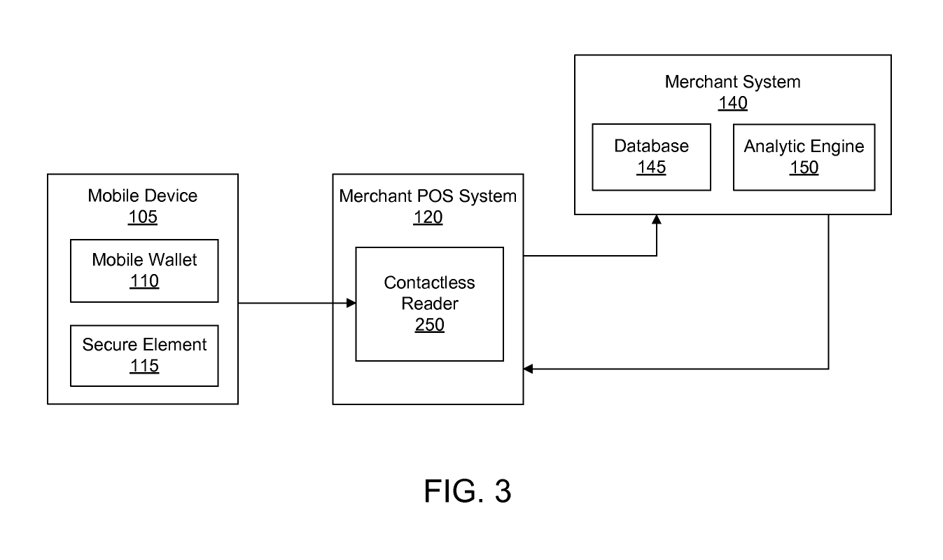

FIG. 3 is a block diagram illustrating some of the components used in a first embodiment. As shown in FIG. 3, the mobile device 105 is capable of communicating with the contactless reader 250, as described above. The contactless reader 250 is part of the merchant POS system 120, which itself is communicatively coupled to the merchant system 140. The merchant system 140 may, in one embodiment, be within the same physical structure as the merchant POS system 120, or could be physically separate.

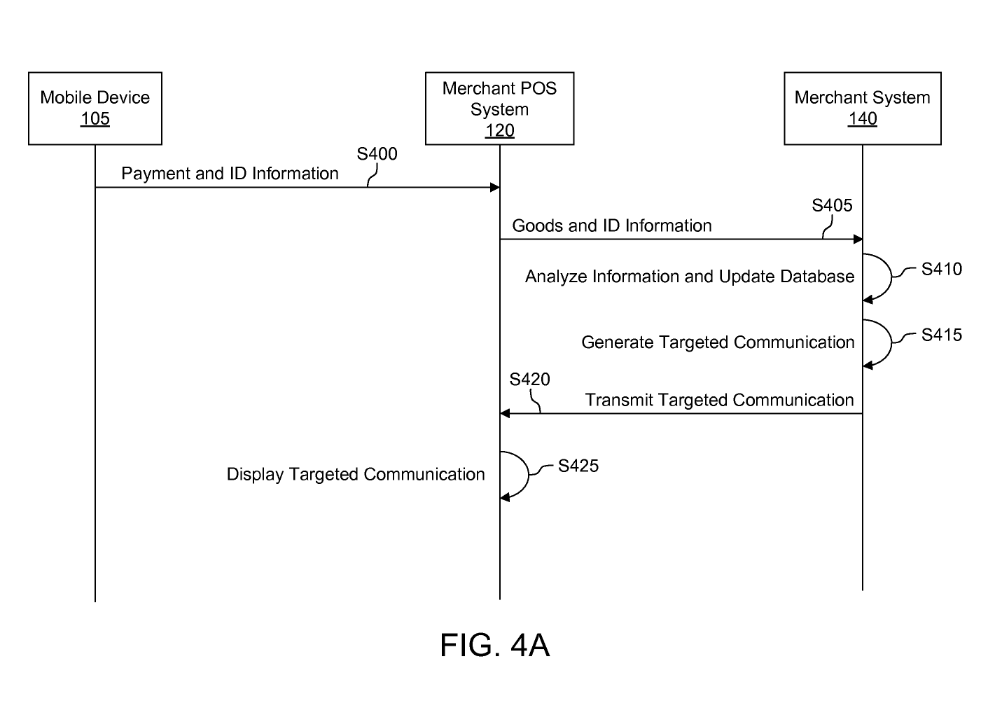

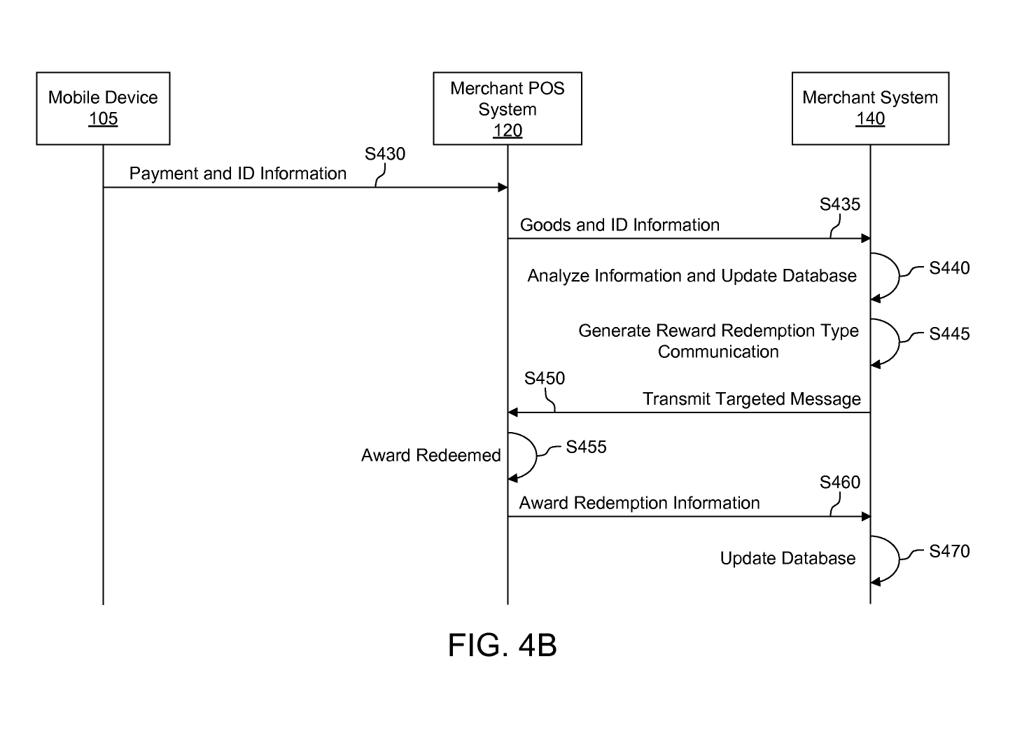

FIG. 4A is a sequence diagram illustrating a method of generating targeted communications according to the first embodiment. In this embodiment, a user taps his or her mobile device 105 to the contactless reader 250, causing CLF 235 to communicate with the contactless reader 250. More specifically, if a purchase is being made, payment applet 235 communicates with payment API 265 to transfer the payment elements. In this embodiment, the CID also is transmitted from secure element 115 on the mobile device 105 to the contactless reader 250. The reader application 260 then transfers the received payment elements and CID to the POS interface 270 and out to the reader interface 285, which is managed by the commercial application data handler 280, completing a transfer of the payment elements and CID to the merchant POS system 120 (S400). If, however, the contactless transaction was not a payment transaction, but some other type of transaction that relates to an application stored on the commerce applet 240, then the relevant elements would be transmitted to the merchant POS system 120 from the commerce applet 240.

In step S405, the merchant POS system 120 transmits the received CID and payment elements (if applicable) to the merchant system 140. If the contactless transaction includes the purchase of goods, information on the goods purchased may also be transmitted to the merchant system 140 from the merchant POS system 120. Still further, other salient information may be transmitted to the merchant system 140 including information on the physical location of the merchant POS system 120. Information regarding the physical location of the merchant POS system 120 may simply be an identification number for merchant POS system 120 or the contactless reader 250 to which it is communicatively coupled. The information may also be the mailing address of the location or its GPS coordinates.

As noted above, merchant system 140 includes an analytic engine 150 and database 145. In step S410, the analytic engine 150 compares the received CID to information stored in profiles in the database 145. A profile is a database entry that includes at least one, and typically more than one, field. Each field stores a type of information. For example, one field stores a CID corresponding to the rest of the information stored in the profile and serves as one mechanism for identifying the profile. Other fields may be used to store the payment elements, items purchased, location of the merchant POS system 120, date and time of the contactless transaction, along with any other type of information desired to be catalogued.

If, in S410, the analytic engine determines that no profile contains a field with a matching CID, then a new profile corresponding to the received CID is generated with at least one field containing the received CID. The newly-generated profile is then updated to include additional fields respectively corresponding to the information received from the merchant POS system 120. If, in S410, the analytic engine determines that a profile contains a field that matches the received CID, then the fields within that profile are updated to include the information received from the merchant POS system 120.

In one example, one of the fields may include a frequency counter representing the number of times that the CID corresponding to the profile, containing that field, has been updated. The analytic engine updates this field by incrementing the counter to indicate that the CID was received (which itself represents that a contactless transaction involving the corresponding mobile device 105 occurred). A profile is not limited to one counter. Additional counters may be provided to track the frequency of other types of information. For example, a counter corresponding to location information (e.g., GPS coordinates) may be provided, and each time that location information is received from the merchant POS system 120, the counter may be updated. Of course, the location information could be any type of information regarding the location of the merchant POS system 120, like the examples discussed above.

The analytic engine 150 is constructed to analyze the information stored in the database to generate targeted communications (S415). There may be a variety of kinds of targeted communications including, for example, offers, coupons, reward, advertising, purchase history, sale, or status information, but the targeted communications may be generally classified into two types. The first type of targeted communications is a reward type targeted communication which includes information indicating that item(s) will be free during the next transaction. Coupons and offers (which show price reductions) may also be considered a reward type targeted communications. The second type of targeted communications is non-reward type targeted communications, which includes advertisements, purchase history, sale, or status information.

The analytic engine 150 may be constructed to generate one or more of these types of messages upon the occurrence of certain events, as determined by an analysis of information within the database 145. For example, if the analytic engine 150 determines that the received CID corresponds to a particular profile and a corresponding counter for that profile is incremented such that the value of the counter is now equal to or greater than a threshold for issuing a reward type targeted communication, then the analytic engine 150 may set a flag, indicating that a reward level has been reached, and generate a reward type targeted communication for transmission to the merchant POS system 120 (S420). Upon receipt of the reward type targeted communication from the merchant system 140, the merchant POS system 120 may display (S425) the communication on its display (not shown). Of course, the display may also display the other types of targeted communications as well.

If the threshold for a reward type targeted communication (as measured through the counter or some other metric) has not been reached, then the analytic engine 150 will generate a status type targeted communication for transmission and display on the merchant POS system 120 in S425. The status type targeted communication indicates the progression to the next reward, and may be accompanied by one or more other types of targeted communications, such as a coupon or offer. For example, an advertising type targeted communication may be displayed concurrently with the status type message on the merchant POS system 120, in order to entice further purchases. In addition to, or in lieu of, the status type message, a transaction receipt may also be included and displayed on the mobile device 105.

If the counter or some other metric indicates that a threshold for a reward was reached in the previous transaction, but was not redeemed in that transaction, then that reward may be redeemed in a subsequent transaction. During the subsequent transaction, a reward redemption process can occur, as shown in FIG. 4B. In S430, the payment information and CID for the subsequent purchase, is transmitted to the merchant POS system 120 through the contactless reader 250 in the same manner as described above. In S435, the CID is transmitted to the merchant system 140 (along with information on the goods purchased). In S440, the analytic engine 150 determines whether a flag, indicating that a reward level has been reached, is set in the profile corresponding to the received CID. The analytic engine may also analyze the purchased goods to determine whether an item therein is reward eligible (S440). If one of the purchased items is reward eligible, then the merchant system 140 will generate a reward redemption type targeted communication (S445), and transmit that communication to the merchant POS system 120 for display (S450). If the reward is redeemed, then information indicating that decision is transmitted to the merchant system 140 (S460). The previous payment is refunded (or partially refunded) through communication with the mobile commerce platform 135. The analytic engine 150 clears the flag in the profile, and sets a new threshold (or simply resets the counter) for a reward type targeted communication in the profile (S470).

The system may also be configured, however, to redeem an earned reward during the same transaction. In this case, if the predetermined threshold for a reward has been reached, a reward type targeted communication is generated and delivered to the merchant POS system 120. If the reward is redeemed at that time, such redemption information is transmitted back to the merchant system 140 and the payment is refunded (or partially refunded) through the mobile commerce platform 135. The analytic engine 150 clears the flag and sets a new threshold (or simply resets the counter) for a reward type targeted communication in the profile.

### Second Embodiment

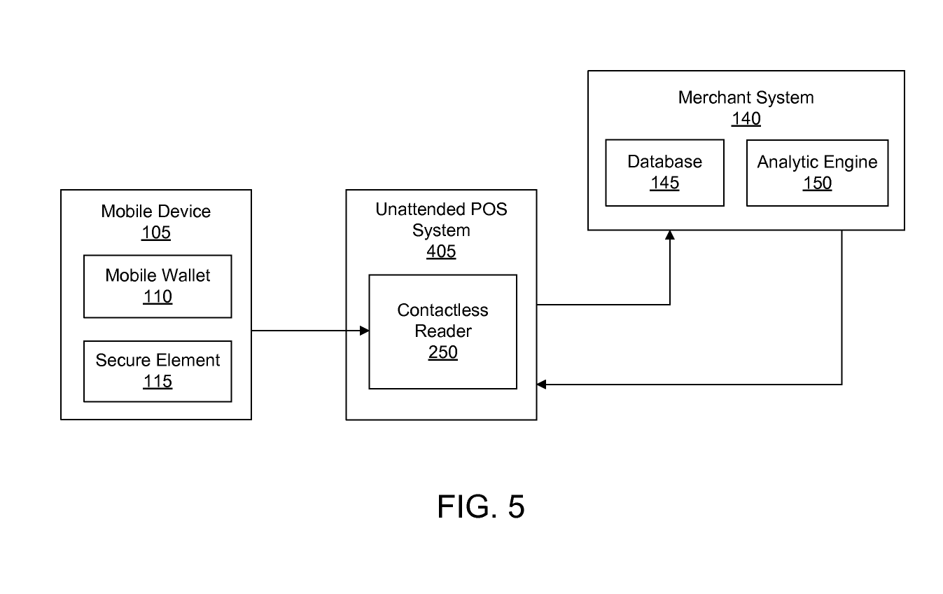

FIG. 5 is a block diagram corresponding to the second embodiment which is directed to a frequency targeted communication system using an unattended point of sale system. FIG. 5 is similar to FIG. 3, except the merchant POS system 120 has been replaced by an unattended POS system 405. An example of an unattended POS system 405 may be a vending machine. The unattended POS system 405 operates without the involvement of an operator, and functions in the same manner as the merchant POS system 120 described above. Moreover, the communications and transmissions of data between the mobile device 105 and the unattended POS system 405 are substantially the same as described above between the mobile device 105 and the merchant POS system 120. Accordingly, discussions of these features are omitted for brevity.

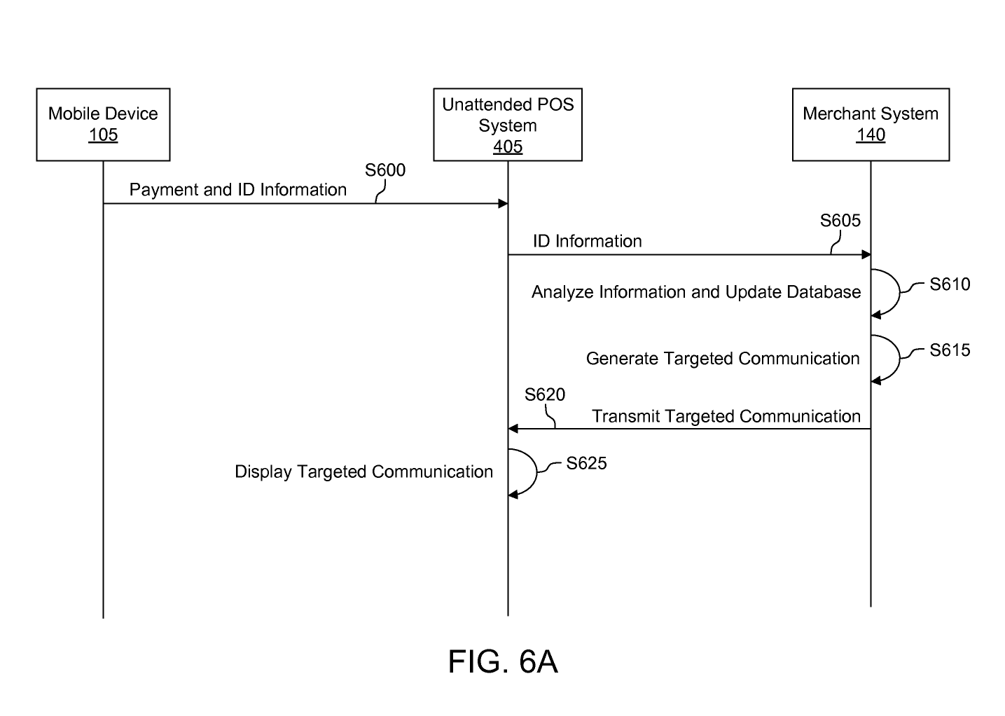

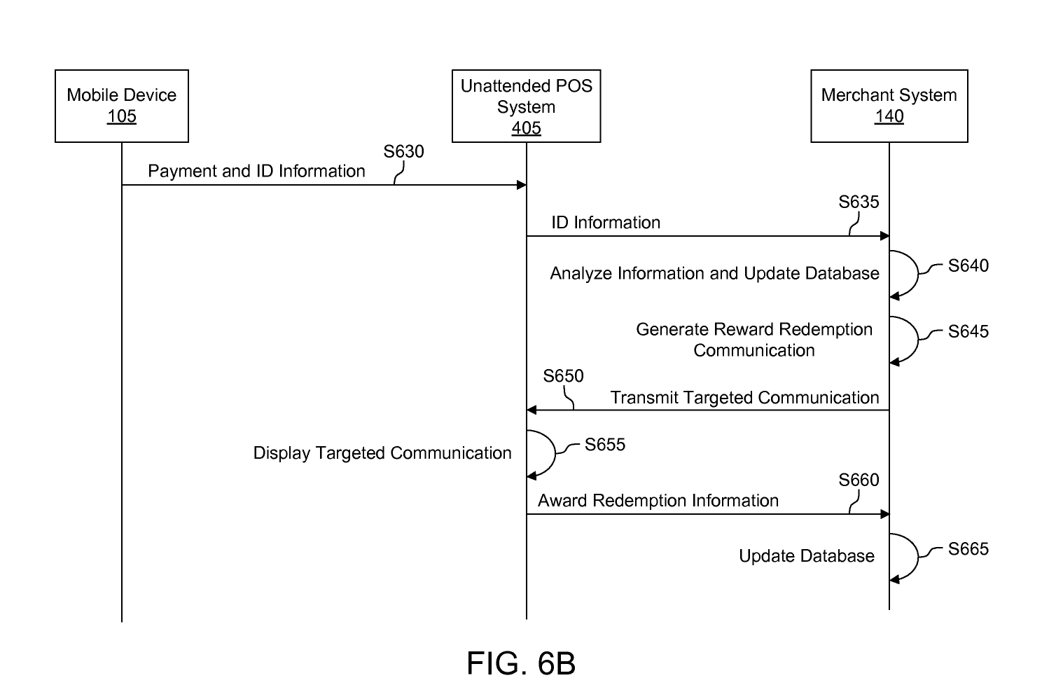

FIG. 6A is a sequence diagram illustrating a consumer's interaction with the unattended POS system 405. Upon purchase of an item from the unattended POS system 405 via the consumer's mobile device 105, the payment elements and CID are transmitted to the unattended POS system 405 (S600). The unattended POS system then transmits the received CID to the merchant system 140 (S605). In this embodiment, information on the goods purchased may be transmitted to the merchant system 140, but typically is not. This stems from the fact that the unattended POS system 405 likely has relatively few offerings for purchase, and that such units are typically equipped with only basic processing and communications infrastructure out of an effort to keep the costs of the unattended POS system 405 low. Of course, the same type of information transmitted to the merchant POS system 120 in the first embodiment, could also be transmitted to the merchant system 140 in the second embodiment.

As in the first embodiment, upon receipt of the CID information, the merchant system 140 analyzes the received CID information and updates the database 145. As in the first embodiment, the analytic engine 150 determines whether a profile exists in the database 145 with a field that contains the same CID value as the CID received from the unattended POS system 405. If so, then a counter value, stored in a field within the profile corresponding to the received CID, is incremented to denote the contactless transaction (e.g., a purchase operation). The analytic engine 150, as in the first embodiment, analyzes the updated profile to determine whether the counter is equal to or greater than a predetermined threshold for issuing a reward type targeted communication. If the counter does not exceed the threshold, then a status type targeted communication is generated (S615) and transmitted to the unattended POS system 405 (S620). If, however, the threshold has been reached or exceeded, then a flag indicating that a reward level has been reached is set in the profile corresponding to the received CID, and a reward type targeted communication is generated (S615) and transmitted to the unattended POS system 405 (S620). In either event, the targeted communication received from the merchant system 140 is displayed on a display (not shown) connected to the unattended POS system 405 (S625).

As in the first embodiment, as shown in FIG. 6B, if the merchant system 140, upon receiving the CID from the unattended POS system (S630 & S635), determines that a flag, indicating a reward level has been reached, is set in a profile corresponding to the received CID, then merchant system 140 generates (S645) and transmits (S650) a reward redemption type targeted communication to the unattended POS system 405 for display. As noted above, goods information is typically not conveyed from the unattended POS system 405 to the merchant system 140. Nevertheless, in an embodiment where such information is transmitted to the merchant system 140, then the analytic engine 150 may further analyze the subsequently purchased goods to ensure that the purchased good is reward eligible. Upon receipt of the reward type targeted communication from the merchant system 140, the unattended POS system 405 automatically displays (S655) a reward redemption type targeted communication, indicating that the corresponding purchase has been refunded (or partially refunded). The unattended POS system 405 then transmits reward redemption information to the merchant system 140 indicating that the reward has been used (S660). The merchant system 140 updates the database 145 accordingly, by clearing the flag in the corresponding profile and setting a new threshold for a reward (S665) (or simply resetting the value of the counter).

### Third Embodiment

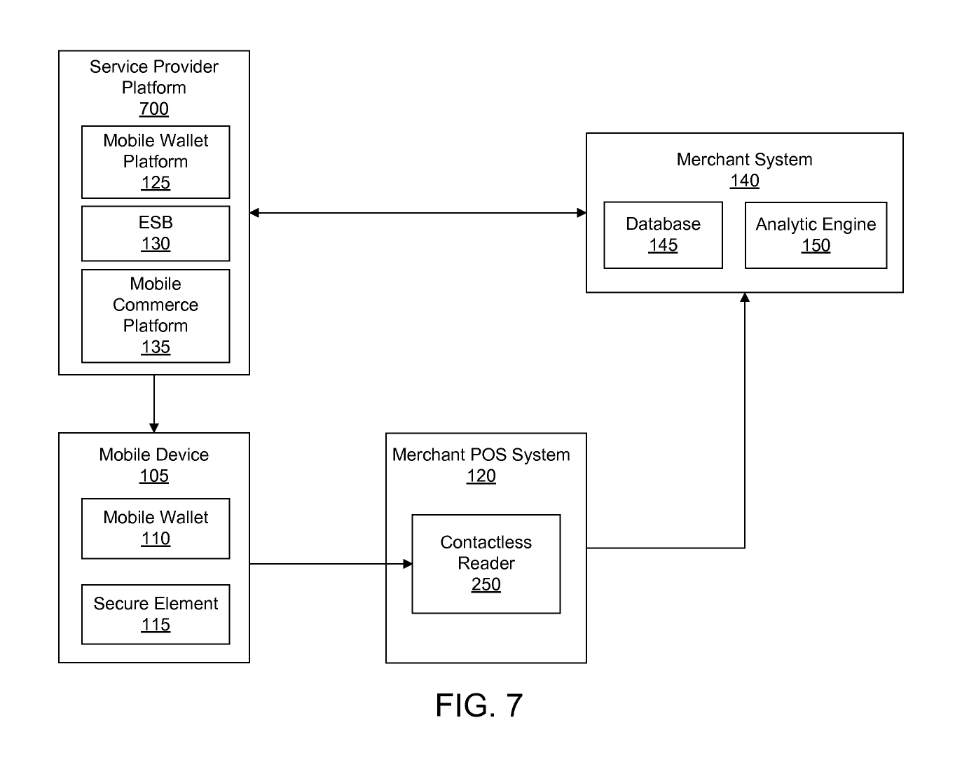

FIG. 7 is a block diagram corresponding to a system of the third embodiment. As in FIG. 3, a mobile device 150 is communicatively coupled to the merchant POS system 120 through the contactless reader 250. The merchant POS system 120 is also communicatively coupled to the merchant system 140. The communications between these elements are substantially the same as discussed above in the first embodiment. Accordingly, a description thereof is omitted for brevity. The merchant system 140 is in bidirectional communication with a service provider platform 700. The service provider platform includes the mobile wallet platform 125, ESB 130, and mobile commerce platform 135.

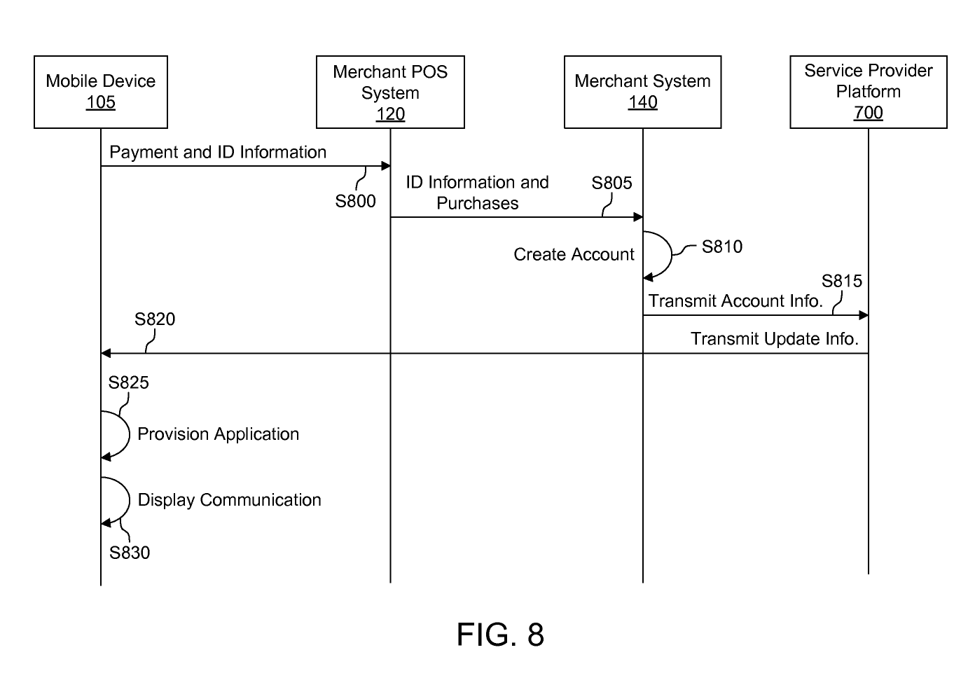

FIG. 8 illustrates one example of a pseudo loyalty type system. When a contactless transaction using a mobile device 105 occurs, the CID is transmitted to the merchant POS system 120 through the contactless reader 250, as described above (S800). The merchant POS system 120 transmits the CID along with, in one embodiment, any purchase information to the merchant system 140 (S805). The merchant system 140 analyzes the database 145 to determine whether an account exists that corresponds to the CID. An account in this embodiment is similar to the profile discussed above. Structurally, the account is the same as the profile, in that it represents a database entry that contains one or more fields which may be populated with a variety of information. The account differs from the profile in that the account is assigned an account number which represents membership in a loyalty program.

If the merchant system 140 determines that an account corresponding to the received CID does not exist in the database 145, then the merchant system 140 creates a new account and assigns the account an account number (S810). As noted above, a merchant system is capable of provisioning onto the secure element 115 one or more commerce applets 240. A commerce applet 240 stores both loyalty and offer related data. The merchant system 140 effects such provisioning by transmitting the account information to the service provider platform 700, specifically the mobile commerce platform 135 (S815). The account information includes the account number and may also include any initial point information assigned according to a loyalty program's calculation (as computed by the analytic engine 150) based on the purchases at the merchant POS system 120. The account information may also be transmitted with a targeted communication that contains, for example, an introductory greeting.

As noted above, the mobile commerce platform 135 includes an offer platform, loyalty platform, and reward platform. In the present embodiment, the account information received by the mobile commerce platform 135 is communicated to the loyalty platform, which in turns generates an instruction set for provisioning a new commerce applet 240 on the mobile device 105. That instruction set is transmitted (S820) to the mobile wallet platform 125 for execution, which results in the provisioning of the new commerce applet 240 on the secure element 115 of the mobile device 105 (S825). If the account information included a targeted communication, then that communication is now displayed on the mobile device 105 (5830).

One of the advantages of the system shown in FIG. 8, is that no additional interaction from the user is required. Since the CID is transmitted during the contactless transaction, the user is not required to complete any additional steps in order to enroll in the merchant's loyalty program. Moreover, the merchant benefits by receiving purchase information from a user who was not previously enrolled in his/her loyalty program. In previous systems, that user's purchase information would have been unavailable to the merchant.

Once enrolled in the pseudo-loyalty program, a user's account number, which is now contained within the commerce applet 240 on the secure element 115, may also be transmitted along with the CID to the merchant POS system 120, and then onto the merchant system 140. The CID and/or account number allow the user to participate in loyalty program savings (such as sales price on certain items) without the need to present a loyalty card or provide any additional information unrelated to the payment process (such as a telephone number or address). The merchant system 140 may from time to time communicate coupons, offers, and rewards to the merchant's commerce applet 240 on the mobile device 105 through the mobile commerce platform 135. These coupons, offers, and rewards may be redeemed during a contactless transaction, as they may be included in the payment elements communicated from the commerce applet 240 to the contactless reader 250 (as described above).

Furthermore, in one example, the mobile wallet service provider can access the information stored in the merchant system database 145 by supplying the merchant system 140 with a user's CID or loyalty account information (or both), which acts as a password. Thus, the mobile wallet service provider can also receive information on contactless transactions at any time from the merchant system 140.

### Fourth Embodiment

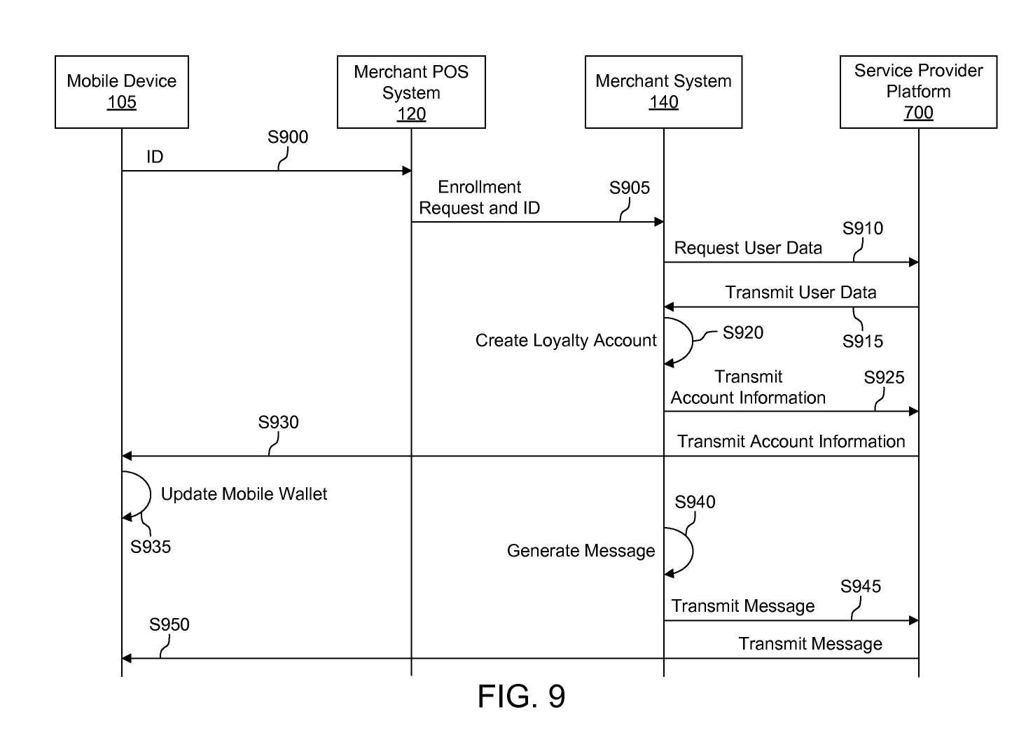

FIG. 9 illustrates a fourth embodiment representing an automated loyalty program enrollment system. The overall system may be structured in the same manner as illustrated in FIG. 7. However, the automated enrollment process need not occur at a point-of-sale system (such as the merchant POS system 120), but may occur at a separate system designated for, among other functions, enrolling consumers in a loyalty program, without processing sales transactions.

In this embodiment, a user initiates a contactless transaction by tapping his/her mobile device 105 to a contactless reader 250 of, in this example, a merchant POS system 120. As discussed above, in addition to other processing described above (and omitted here for brevity), the CID is transmitted to the merchant POS system 120 (S900). In addition, the commercial application data handler 280 generates a query asking if the user would like to enroll in the merchant's loyalty program. The query is transmitted through the reader interface 285 to the POS interface 270 and subsequently transmitted to the mobile device 105 through the CLF 235. Processor 205 causes the query to be displayed on the mobile device display (not shown). An election can then be made as to whether to enroll in the merchant's loyalty program. Regardless of the election, the information regarding the same is transmitted to the contactless reader 250 through the CLF 235 and then transmitted to the commercial application data handler 280, through the POS interface 270 and the reader interface 285. If the election is to participate in the merchant's loyalty program, then an enrollment request and the CID are transmitted from the merchant POS system to the merchant system 140 (S905).

Upon receipt of the enrollment request and the CID, the merchant system 140 requests salient user data from the service provider platform 700 (S910), which the merchant system 140 will use to create the loyalty account in the database 145 and populate the fields therein. Prior to transmitting such information, however, the merchant system's 140 credentials are challenged by the mobile commerce platform 135 to ensure that the merchant system 140 is authorized to access such information. If the challenges are successful, then the service provider platform 700 sends the user's data to the merchant system 140 (S915). The merchant system 140 generates a loyalty account in the database 145 and the analytic engine uses the received user data to populate various fields, such as name, address, telephone number, and the like (S920). Once the account has been generated, the merchant system 140 provides the account information to the service provider platform 700, specifically the mobile commerce platform 135 (S925). Such information may include, for example, the loyalty account number.

The mobile commerce platform 135 transmits the account information to the commerce platform, which in turns generates an instruction set for provisioning a new commerce applet 240 on the mobile device 105. That instruction set is transmitted (S930) to the mobile wallet platform 125 for execution, which results in the provisioning of the new commerce applet 240 on the secure element 115 of the mobile device 105 (S935).

The merchant system may also generate a targeted communication for transmission to the mobile wallet 110 (S940). The targeted communication may be an initial greeting and/or another type of targeted communication such as a coupon, offer, or even a reward. The merchant system 140 transmits the targeted communication to the service provider platform 700 (S945), which in turn transmits the targeted communication to the mobile device 105 (S950).

### Fifth Embodiment

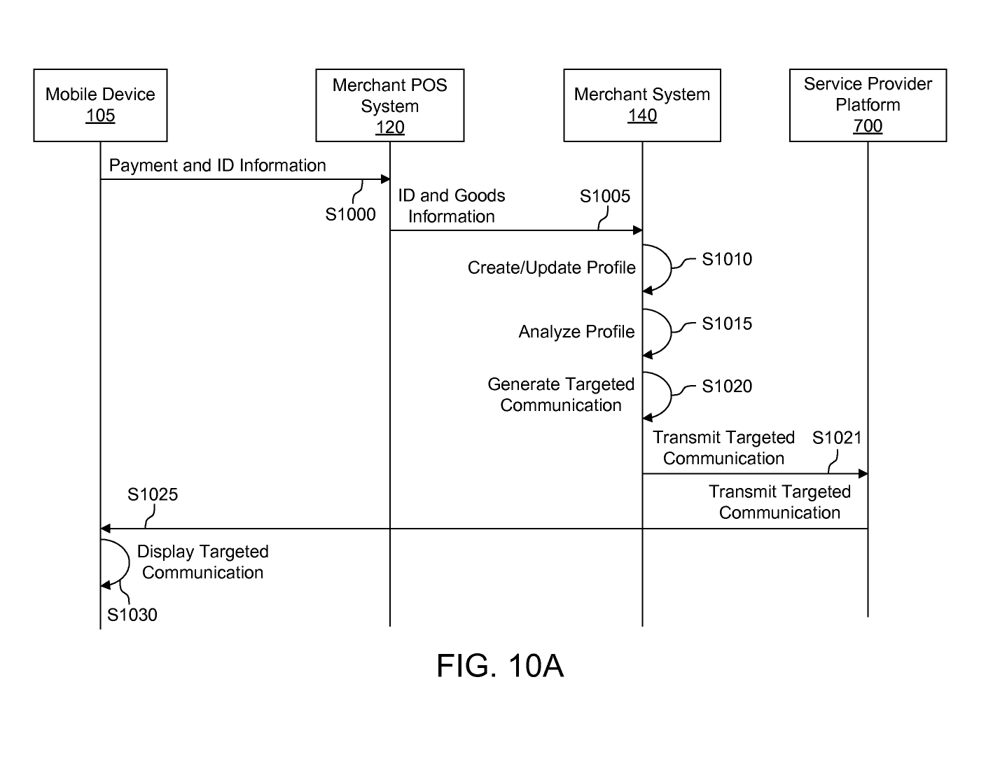

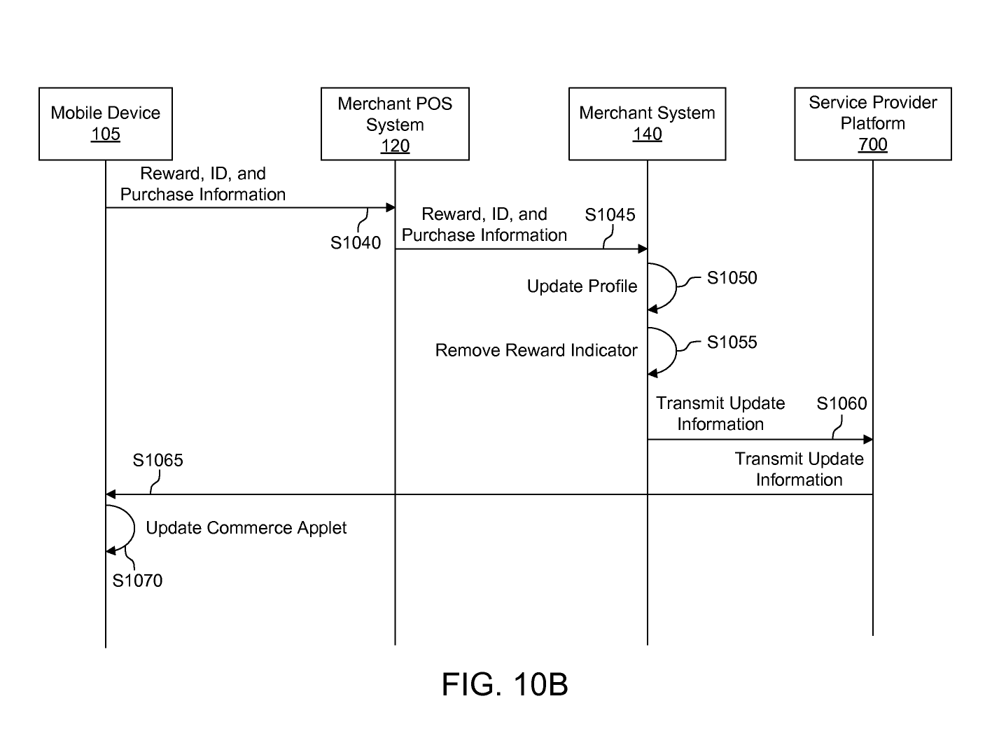

FIG. 10A is a sequence diagram illustrating a pseudo loyalty and targeted communication system operation. The overall system may be structured in substantially the same manner as illustrated in FIG. 7. The operation of this system is similar to the operation of the first embodiment, except, as described below, the targeted communication is transmitted to the service provider platform 700 rather than the merchant POS system 120.

As shown in FIG. 10A, payment elements and the CID are transferred to a contactless reader 250 in the merchant POS system 120 during a contactless transaction, as described above (S1000). The CID and the purchase information are transferred to the merchant system 140 (S1005). The merchant system 140 analyzes the received CID to determine whether a corresponding profile in database 145 exists. If not, then the merchant system 140 creates such a profile in the database 145, and populates its fields according the CID and purchase information received from the merchant POS system 120.

As discussed above, the analytic engine 150 is configured to analyze the information stored within the profile and generate targeted communications in accordance with that analysis. Also as discussed above, one type of targeted communication is a reward type targeted communication. When the analytic engine 150 determines that a reward level has been reached, as described below, a flag is set in the profile indicating that a reward is available, and a corresponding reward type targeted communication is generated for transmission to the service provider platform 700, and from there to the mobile device 105.

The analytic engine 150 may employ a variety of different analyses to determine whether a reward level has been reached, depending upon the merchant's intentions. For example, the analytic engine 150 may employ a simple frequency counter whose value is stored in a field and corresponds to the number of times the CID has been received by the merchant system 140. The analytic engine 150 may be configured to generate a reward type targeted communication when the counter value exceeds a predetermined value.

Moreover, the analytic engine 150 may also be configured to analyze the total value of the goods purchased by summing the price information stored in one of the fields within the profile. The analytic engine 150 may be configured to generate a reward type targeted communication when the sum value of the goods purchased exceeds a predetermined threshold. Of course, the use of the total value of the goods purchased may be substituted as a metric for other information stored in a different field within the profile to determine whether a reward threshold has been reached including, for example, the quantity of items purchased, the quantity of any particular item, or the dollar value of any particular items.

Still further, if the merchant POS system 120 transmits additional information, such as geographical information, that information could also be used to determine whether to generate a reward-type targeted communication. By using geographic information, the analytic engine 150 may track the user's purchases at several different locations and even generate location-based targeted communications. For example, a user may receive a special reward for conducting contactless transactions at multiple store locations.

Once the analytic engine 150 has analyzed the updated (or created) profile (S1010 and S1015), the analytic engine 140 generates a targeted communication (S1020) and transmits that targeted communication to the service provider platform 700, specifically the mobile commerce platform 135 (S1021). The mobile commerce platform 135 analyzes the contents of the targeted communication to determine whether it is necessary to provision a new commerce applet 240 on the secure element 115 (as described above). If the targeted communication is a reward-type targeted communication, then the mobile commerce platform 135 analyzes the reward information, included in the targeted communication, and updates the commerce applet 240 accordingly (S1025). Doing so allows for such reward information to be available for transmission to the merchant POS system 120 in a subsequent transaction. Finally, if the targeted communication includes a graphical display, then those graphical elements are transmitted to the memory 200 on the mobile device and then caused to be displayed on the display of the mobile device (not shown) (S1030).

FIG. 10B is a sequence diagram illustrating the process of redeeming a reward-type targeted communication according to the fifth embodiment. As discussed above, the mobile commerce platform 135 receives the reward type targeted communication from the merchant system 140, and updates a corresponding commerce application on the secure element 115 accordingly.

As shown in FIG. 10B, when a contactless transaction is subsequently initiated with the mobile device 105, the mobile device 105 transfers to the contactless reader 250 the CID along with the reward and purchase elements contained in the commerce applet 240 (S1040). The merchant POS system 120 in turn transfers the CID, the reward and purchase elements, and information on the goods purchased by the user, to the merchant system 140 (S1045). The analytic engine 150 proceeds to update the consumer profile based on such information (S1050). The analytic engine 150 may also compare the reward elements transmitted from the mobile device 105 with the goods purchased to determine whether a qualifying purchase was made. If so, then the merchant system 140 sends a refund request (or a partial refund request as the case may be) to the mobile commerce platform 135 for processing. The analytic engine 150 then removes the flag indicating that a reward level has been reached and resets the threshold for indicating a reward level to an appropriate value (S1055). The merchant system 140 then transmits an update to the mobile device 105 (S1060 and S1065), through the service provider platform 700. Since the update indicates that the reward has been redeemed, the mobile commerce platform 135 generates an instruction set for removing the reward elements from the commerce applet 240, and transfers that instruction set to the mobile wallet platform for execution by the mobile device 105 (S1070).

### Sixth Embodiment

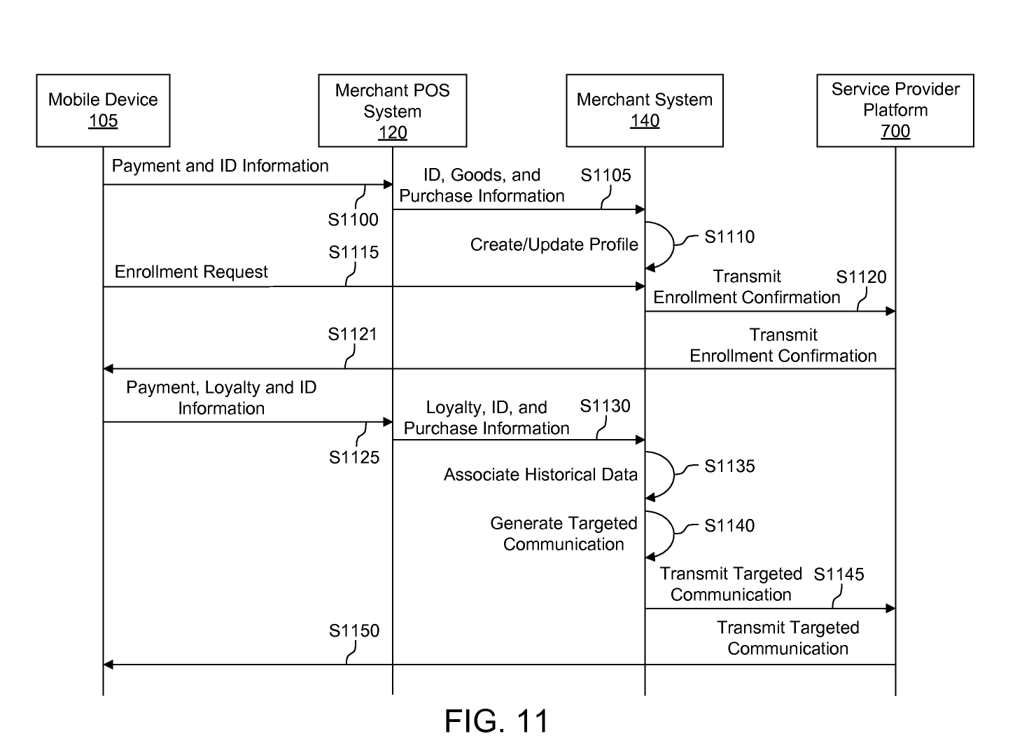

FIG. 11 is a sequence diagram illustrating a historically-enriched method of generating targeted communications according to the sixth embodiment. As discussed above, a mobile device may be used to make contactless transactions, without enrolling in a merchant's loyalty program. However, should the user later elect to enroll in the merchant's loyalty program, then the user's historical transaction data may be used to populate a corresponding profile stored in database 145 as discussed below.

Assume a mobile device 105, whose user is not enrolled in a merchant's loyalty program, makes a contactless transaction at the merchant POS system 120. As described above, the CID and purchase elements are transferred from the mobile device 105 to the contactless reader 250 of the merchant POS system 120 (S1100). The CID and purchase information are then transferred to the merchant system 140, along with information on the goods purchased (S1105). The merchant system 140 compares the received CID to CIDs stored in the database 145 and respectively associated with a plurality of profiles, to determine whether a corresponding profile exists. If a corresponding profile does not exist, then the merchant system 140 creates a corresponding profile and populates that profile with the CID and purchase information (along with the information on the purchased goods) received from the merchant POS system 120. If a corresponding profile does exist, then the merchant system 140 updates the corresponding profile to include the purchase information (along with the information on the purchased goods) received from the merchant POS system 120 (S1110).

Should the user later choose to enroll in the merchant's loyalty program (S1115) through a contactless transaction, then that enrollment request is received by the merchant system 140 (S1115) processed. More specifically, an account is generated in the database 145 and the fields therein are populated with the information provided by the mobile device 105 (or alternatively the user through another medium). Once the account is generated, an enrollment confirmation is transmitted to the mobile device 105, via the mobile commerce platform 135 and the mobile wallet platform 125 (S1120 and S1121). Commerce applet 240 is then updated to include corresponding loyalty information, such as a loyalty account number.

Of course, as discussed above, the enrollment request may be received by the merchant POS system 120, or another merchant system comprising a contactless reader, and then forwarded to the merchant system 140. Alternatively, the user may use his/her data connection on the mobile device 105 to enroll in the loyalty program through the Internet. In any event, when the mobile device 105 is subsequently presented for a contactless transaction at the merchant POS system 120, the CID, loyalty information, and payment elements are transferred to the merchant POS system 120 (S1125) and then transmitted to the merchant system 140 (S1130). The merchant system 140 associates the received CID and received loyalty information, and then analyzes the database 145 to determine whether the database contains historical transaction data stored in a profile that corresponds to the received CID. If so, then the merchant system 140 associates the historical transaction data with the loyalty information, and populates the fields within the profile with the loyalty information (S1135). The merchant system 140 then generates a corresponding targeted communication (S1140). If the merchant system 140 determined that historical data corresponding to the received CID is contained within the database 145 and successfully associated that data with the received loyalty information, then the merchant system 140 generates a targeted communication notifying of the successful association.

Of course, the merchant system 140 could be configured to generate additional targeted communications as well. For example, if the successful association results in a reward indicator crossing a predetermined threshold for issuing a reward type targeted communication, then such a message may be transmitted along with the notification of successful association in S1140. Regardless of the type of targeted communication generated in S1140, the targeted communication is then relayed to the service provider platform 700 (S1145) which, in turn, relays the targeted communication to the mobile device 105 (S1150).

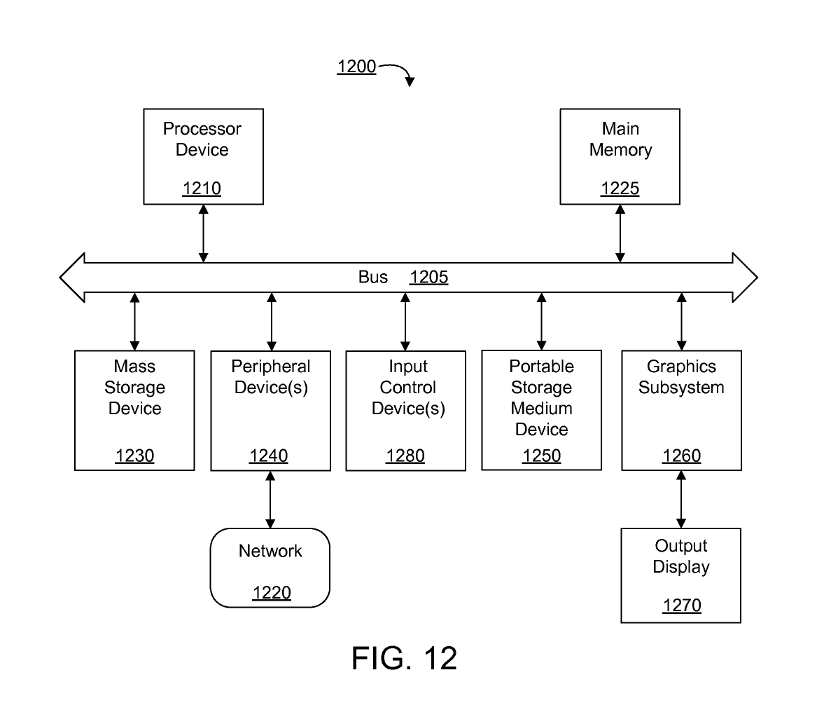

FIG. 12 is a block diagram of a general and/or special purpose computer 1200, which may be a general and/or special purpose computing device, in accordance with some of the example embodiments of the invention. The computer 1200 may be, for example, a user device, a user computer, a client computer and/or a server computer, among other things.

The computer 1200 may include without limitation a processor device 1210, a main memory 1225, and an interconnect bus 1205. The processor device 1210 may include without limitation a single microprocessor, or may include a plurality of microprocessors for configuring the computer 1200 as a multi-processor system. The main memory 1225 stores, among other things, instructions and/or data for execution by the processor device 1210. The main memory 1225 may include banks of dynamic random access memory (DRAM), as well as cache memory.

The computer 1200 may further include a mass storage device 1230, peripheral device(s) 1240, portable non-transitory storage medium device(s) 1250, input control device(s) 1280, a graphics subsystem 1260, and/or an output display interface 1270. For explanatory purposes, all components in the computer 1200 are shown in FIG. 7 as being coupled via the bus 1205. However, the computer 1200 is not so limited. Devices of the computer 1200 may be coupled via one or more data transport means. For example, the processor device 1210 and/or the main memory 1225 may be coupled via a local microprocessor bus. The mass storage device 1230, peripheral device(s) 1240, portable storage medium device(s) 1250, and/or graphics subsystem 1260 may be coupled via one or more input/output (I/O) buses. The mass storage device 1230 may be a non-volatile storage device for storing data and/or instructions for use by the processor device 1210. The mass storage device 1230 may be implemented, for example, with a magnetic disk drive or an optical disk drive. In a software embodiment, the mass storage device 1230 is configured for loading contents of the mass storage device 1230 into the main memory 1225.

The portable storage medium device 1250 operates in conjunction with a non-volatile portable storage medium, such as, for example, a compact disc read only memory (CD-ROM), to input and output data and code to and from the computer 1200. In some embodiments, the software for storing information may be stored on a portable storage medium, and may be inputted into the computer 1200 via the portable storage medium device 1250. The peripheral device(s) 1240 may include any type of computer support device, such as, for example, an input/output (I/O) interface configured to add additional functionality to the computer 1200. For example, the peripheral device(s) 1240 may include a network interface card for interfacing the computer 1200 with a network 1220.

The input control device(s) 1280 provide a portion of the user interface for a user of the computer 1200. The input control device(s) 1280 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 1200 may include the graphics subsystem 1260 and the output display 1270. The output display 1270 may include a cathode ray tube (CRT) display and/or a liquid crystal display (LCD). The graphics subsystem 1260 receives textual and graphical information, and processes the information for output to the output display 1270.

Each component of the computer 1200 may represent a broad category of a computer component of a general and/or special purpose computer. Components of the computer 1200 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine accessible machine readable or computer-readable medium may be used to program a computer system or other electronic device. The machine- or computer-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “computer-readable”, “machine accessible-medium” or “machine-readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Portions of the example embodiments of the invention may be conveniently implemented by using a conventional general purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field-programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation, device drivers, operating systems and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method of generating a targeted communication, comprising:
receiving user identification information from a contactless reading unit;
updating a profile corresponding to the user identification information based on the received user identification information;
determining a type of targeted communication for transmission based on the profile; and
generating a targeted communication based on the determining.

2. The method according to claim 1, wherein a first type of targeted communication is a reward type targeted communication, and a second type of targeted communication is an advertising, transaction history, or status type targeted communication.

3. The method according to claim 2, wherein, in a case where the determining indicates that a predetermined condition has been met, the first type of targeted communication is generated, otherwise the second type of targeted communication is generated.

4. The method according to claim 3, further comprising:
setting an indicator in the profile to a first state in the case where the determining indicates that the predetermined condition has been met.

5. The method according to claim 4, further comprising:
receiving redemption information from the contactless reading unit,
wherein the indicator is set to a second state indicating that the predetermined condition has not been met upon receipt of the redemption information from the contactless reading unit.

6. The method according to claim 3, further comprising:
incrementing a counter corresponding to the profile upon receipt of the user identification information from the contactless reading unit,
wherein when the counter is equal to or greater than a predetermined value the predetermined condition has been met.

7. The method according to claim 1, further comprising:
receiving account information from a contactless transaction unit; and
associating the profile corresponding to the user identification information with the received account information,
wherein the targeted communication is determined based on the associated profile.

8. An apparatus for generating a targeted communication, comprising:
a communication unit constructed to receive user identification information from a contactless reading unit;
a memory constructed to store a database that includes a profile corresponding to the received user identification information; and
an analytic engine embodied in a processor that is constructed to:
update the profile corresponding to the received user identification information based on the received user identification information,
determine a type of targeted communication for transmission based on the profile, and
generate a targeted communication based on the determination.

9. The apparatus according to claim 8, wherein a first type of targeted communication is a reward type targeted communication, and a second type of targeted communication is an advertising, transaction history, or status type targeted communication.

10. The apparatus according to claim 9, wherein, in a case where the determination indicates that a predetermined condition has been met, the first type of targeted communication is generated, otherwise the second type of targeted communication is generated.

11. The apparatus according to claim 10, wherein the analytic engine is further constructed to set an indicator in the profile to a first state in the case where the determination indicates that the predetermined condition has been met.

12. The apparatus according to claim 11, wherein the communication unit is further constructed to receive redemption information from the contactless reading unit, and
wherein the analytic engine is further constructed to set the indicator to a second state indicating that the predetermined condition has not been met upon receipt of the redemption information from the contactless reading unit.

13. The apparatus according to claim 11, wherein the profile corresponding to the received user identification information further includes a counter,
wherein the analytic engine is further constructed to increment the counter upon the receipt of the user identification information from the contactless reading unit, and
wherein when the counter is equal to or greater than a predetermined value the predetermined condition has been met.

14. The apparatus according to claim 8, wherein the communication unit is further constructed to receive account information from a contactless transaction unit, and the analytic engine is further constructed to associate the profile corresponding to the user identification information with the received account information,
wherein the targeted communication is determined based on the associated profile.

15. A non-transitory computer readable storage medium storing a program configured to cause an apparatus to execute a method of generating a targeted communication, the method comprising:
receiving user identification information from a contactless reading unit;
updating a profile corresponding to the user identification information based on the received user identification information;
determining a type of targeted communication for transmission based on the profile; and
generating a targeted communication based on the determining.

16. The computer readable storage medium according to claim 15, wherein a first type of targeted communication is a reward type targeted communication, and a second type of targeted communication is an advertising, transaction history, or status type targeted communication.

17. The computer readable storage medium according to claim 16, wherein, in a case where the determining indicates that a predetermined condition has been met, the first type of targeted communication is generated, otherwise the second type of targeted communication is generated.

18. The computer readable storage medium according to claim 17, wherein the method further comprises:
setting an indicator in the profile to a first state in the case where the determining indicates that the predetermined condition has been met.

19. The computer readable storage medium according to claim 18, wherein the method further comprises:
receiving redemption information from the contactless reading unit,
wherein the indicator is set to a second state indicating that the predetermined condition has not been met upon receipt of the redemption information from the contactless reading unit.

20. The computer readable storage medium according to claim 17, wherein the method further comprises:
incrementing a counter corresponding to the profile upon receipt of the user identification information from the contactless reading unit,
wherein when the counter is equal to or greater than a predetermined value the predetermined condition has been met.

21. A method of generating a user account, comprising:
receiving user identification information from a contactless transaction unit; and
generating a user account based on the received user identification information;

22. The method according to claim 21, further comprising:
receiving an enrollment request from the contactless transaction unit;
requesting, in response to the received enrollment request, user data corresponding to the received user identification information from an external apparatus; and
receiving from the external apparatus the requested user data corresponding to the received user identification information.

23. The method according to claim 22, wherein the user account is generated based on the received user data corresponding to the user identification information.

24. The method according to claim 23, wherein the received user data contains personal information regarding the user and is used, in the generation of the user account, to populate data fields respectively corresponding to the personal information.
